(19) United States
(12) Patent Application Publication
(10) Pub. No.: US 2023/0094630 A1
(43) Pub. Date: Mar. 30, 2023

(54) METHOD AND SYSTEM FOR ACOUSTIC ECHO CANCELLATION

(71) Applicant: BEIJING DIDI INFINITY TECHNOLOGY AND DEVELOPMENT CO., LTD., Beijing (CN)

(72) Inventors: Yi ZHANG, Mountain View, CA (US); Chengyun DENG, Beijing (CN); Shiqian MA, Beijing (CN); Yongtao SHA, Beijing (CN); Hui SONG, Beijing (CN)

(73) Assignee: BEIJING DIDI INFINITY TECHNOLOGY AND DEVELOPMENT CO., LTD., Beijing (CN)

(21) Appl. No.: 18/062,556

(22) Filed: Dec. 6, 2022

Related U.S. Application Data
(63) Continuation of application No. PCT/CN2020/121024, filed on Oct. 15, 2020.

(51) Int. Cl. G06N 3/08; G06V 10/82

(52) U.S. Cl. CPC G06N 3/08; G06V 10/82; G06T 2207/20081

(57) ABSTRACT

Methods, systems, and apparatus, including computer programs encoded on computer storage media for acoustic echo cancellation and suppression are provided. An exemplary method comprises receiving a far-end acoustic signal and a corrupted near-end acoustic signal, wherein the corrupted near-end acoustic signal is generated based on (1) an echo of the far-end acoustic signal and (2) a near-end acoustic signal; feeding the far-end acoustic signal and the corrupted near-end acoustic signal into a neural network as an input to output a time-frequency (TF) mask that suppresses the echo and retains the near-end acoustic signal, and generating an enhanced version of the corrupted near-end acoustic signal by applying the obtained TF mask to the corrupted near-end acoustic signal.

### CROSS-REFERENCE TO RELATED APPLICATIONS

This application is a Continuation of International Application No. PCT/CN2020/121024, filed on Oct. 15, 2020, the contents of which are incorporated herein by reference in their entirety.

### TECHNICAL FIELD

The disclosure relates generally to systems and methods for acoustic echo cancellation, in particular, generative adversarial network (GAN) based acoustic echo cancellation.

### BACKGROUND

Acoustic echo originates in a local audio loopback that occurs when a near-end microphone picks up audio signals from a speaker and sends it back to a far-end participant. The acoustic echo can be extremely disruptive to a conversation over the network. Acoustic echo cancellation (AEC) or suppression (AES) aims to suppress (e.g., remove, reduce) echoes from microphone signal while leaving the speech of near-end talker least distorted. Conventional echo cancellation algorithms estimate the echo path by using an adaptive filter, under the assumption of a linear relationship between far-end signal and acoustic echo. In reality, this linear assumption usually does not hold. As a result, post-filers are often deployed to suppress the residue echo. However, the performance of such AEC algorithms drops drastically when nonlinearity is introduced. Although some nonlinear adaptive filters have been proposed, they are too expensive to implement. Therefore, a novel and practical design for acoustic echo cancellation is desirable.

### SUMMARY

Various embodiments of the present specification may include systems, methods, and non-transitory computer readable media for acoustic echo cancellation based on Generative Adversarial Network (GAN).

According to one aspect, the GAN based method for acoustic echo cancellation comprises receiving a far-end acoustic signal and a corrupted near-end acoustic signal, wherein the corrupted near-end acoustic signal is generated based on (1) an echo of the far-end acoustic signal and (2) a near-end acoustic signal; feeding the far-end acoustic signal and the corrupted near-end acoustic signal into a neural network as an input to output a time-frequency (TF) mask that suppresses the echo and retains the near-end acoustic signal, wherein: the neural network comprises an encoder and a decoder coupled to each other, the encoder comprises one or more convolutional layers, and the decoder comprises one or more deconvolutional layers that are respectively mapped to the one or more convolutional layers, wherein the input of the neural network passes through the convolutional layers and the deconvolutional layers; and generating an enhanced version of the corrupted near-end acoustic signal by applying the obtained TF mask to the corrupted near-end acoustic signal.

In some embodiments, the corrupted signal generated from the far-end acoustic signal is obtained by a near-end device when the far-end acoustic signal is propagated from a far-end device to the near-end device.

In some embodiments, the neural network comprises a generator neural network jointly trained with a discriminator neural network by: obtaining training data comprising a training far-end acoustic signal, a training near-end acoustic signal, and a corrupted version of the training near-end acoustic signal; generating an estimated TF mask by the generator neural network based on the training far-end acoustic signal and the corrupted version of the training near-end acoustic signal; obtaining an enhanced version of the training near-end acoustic signal by applying the estimated TF mask to the corrupted version of the training near-end acoustic signal; generating, by the discriminator neural network, a score quantifying a resemblance between the enhanced version of the training near-end acoustic signal and the training near-end acoustic signal; and training the generator neural network based on the generated score.

In some embodiments, a loss function for training the discriminator neural network comprises a normalized evaluation metric that is determined based on: a perceptual evaluation of speech quality (PESO) metric of the enhanced version of the training near-end acoustic signal; an echo return loss enhancement (ERLE) metric of the enhanced version of the training near-end acoustic signal; or a weighted sum of the PESO metric and the ERLE metric of the enhanced version of the training near-end acoustic signal.

In some embodiments, the discriminator neural network comprises one or more convolutional layers and one or more fully connected layers.

In some embodiments, the generator neural network and the discriminator neural network are jointly trained as a Generative Adversarial Network (GAN).

In some embodiments, the score comprises: a perceptual evaluation of speech quality (PESO) score of the enhanced version of the training near-end acoustic signal; an echo return loss enhancement (ERLE) score of the enhanced version of the training near-end acoustic signal; or a weighted sum of the PESQ score and the ERLE score.

In some embodiments, the training data further comprises a ground-truth mask based on the training far-end acoustic signal, the training near-end acoustic signal, and the corrupted version of the training near-end acoustic signal, and the score further comprises a normalized distance between the ground-truth mask and the estimated TF mask.

In some embodiments, the neural network further comprises one or more bidirectional Long-Short Term Memory (LSTM) layers between the encoder and the decoder.

In some embodiments, each of the convolution layers has a direct channel to pass data directly to a corresponding deconvolution layer through a skip connection.

In some embodiments, the far-end acoustic signal comprises a speaker signal, the near-end acoustic signal comprises a target microphone input signal to a microphone, the corrupted signal generated from the far-end acoustic signal comprises an echo of the speaker signal that is received by the microphone, and the corrupted near-end acoustic signal comprises the target microphone input signal and the echo.

According to another aspect, a system for acoustic echo cancellation may comprise one or more processors and one or more non-transitory computer-readable memories coupled to the one or more processors, the one or more non-transitory computer-readable memories storing instructions that, when executed by the one or more processors, cause the system to perform operations comprising: receiving a far-end acoustic signal and a corrupted near-end acoustic signal, wherein the corrupted near-end acoustic signal is generated based on (1) an echo of the far-end acoustic signal and (2) a near-end acoustic signal; feeding the far-end acoustic signal and the corrupted near-end acoustic signal into a neural network as an input to output a time-frequency (TF) mask that suppresses the echo and retains the near-end acoustic signal, wherein: the neural network comprises an encoder and a decoder coupled to each other, the encoder comprises one or more convolutional layers, and the decoder comprises one or more deconvolutional layers that are respectively mapped to the one or more convolutional layers, wherein the input of the neural network passes through the convolutional layers and the deconvolutional layers; and generating an enhanced version of the corrupted near-end acoustic signal by applying the obtained TF mask to the corrupted near-end acoustic signal.

According to yet another aspect, an non-transitory computer-readable storage medium may store instructions that, when executed by one or more processors, cause the one or more processors to perform operations comprising: receiving a far-end acoustic signal and a corrupted near-end acoustic signal, wherein the corrupted near-end acoustic signal is generated based on (1) an echo of the far-end acoustic signal and (2) a near-end acoustic signal; feeding the far-end acoustic signal and the corrupted near-end acoustic signal into a neural network as an input to output a time-frequency (TF) mask that suppresses the echo and retains the near-end acoustic signal, wherein: the neural network comprises an encoder and a decoder coupled to each other, the encoder comprises one or more convolutional layers, and the decoder comprises one or more deconvolutional layers that are respectively mapped to the one or more convolutional layers, wherein the input of the neural network passes through the convolutional layers and the deconvolutional layers; and generating an enhanced version of the corrupted near-end acoustic signal by applying the obtained TF mask to the corrupted near-end acoustic signal.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 illustrates an exemplary system to which Generative Adversarial Network (GAN) based acoustic echo cancellation (AEC) may be applied, in accordance with various embodiments.

FIG. 2 illustrates an exemplary training process for GAN-based AEC, in accordance with various embodiments.

FIG. 3 illustrates an exemplary architecture of a generator for GAN-based AEC, in accordance with various embodiments.

FIG. 4 illustrates an exemplary architecture of a discriminator for GAN-based AEC, in accordance with various embodiments.

FIG. 5 illustrates another exemplary training process of a generator and a discriminator for GAN-based AEC, in accordance with various embodiments.

FIG. 6 illustrates a block diagram of a computer system apparatus for GAN-based AEC in accordance with various embodiments.

FIG. 7 illustrates an exemplary method for GAN-based AEC, in accordance with various embodiments.

FIG. 8 illustrates a block diagram of a computer system in which any of the embodiments described herein may be implemented.

### DETAILED DESCRIPTION

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

Some embodiments in this disclosure describe a GAN-based Acoustic Echo Cancellation (AEC) architecture, method, and system for both linear and nonlinear echo scenarios. In some embodiments, an exemplary architecture involves a generator and a discriminator trained in an adversarial manner. In some embodiments, the generator is trained in the frequency domain and predicts the time-frequency (TF) mask for a target speech, and the discriminator is trained to evaluate the TF mask output by the generator. In some embodiments, the evaluation from the discriminator may be used to update the parameters of the generator. In some embodiments,, several disclosed metric loss functions may be deployed for training the generator and the discriminator.

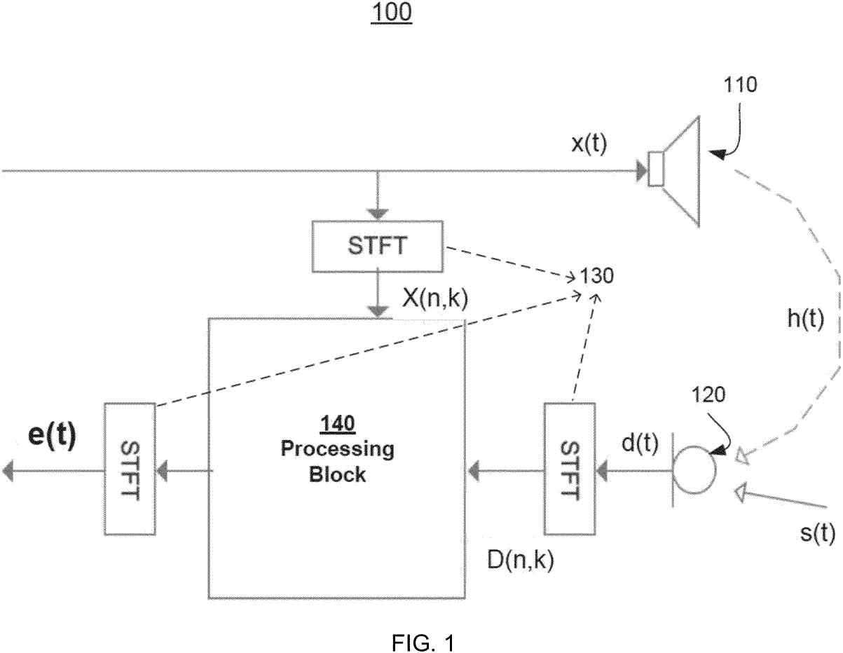

FIG. 1 illustrates an exemplary system 100 to which Generative Adversarial Network (GAN) based acoustic echo cancellation (AEC) may be applied, in accordance with various embodiments.

The exemplary system 100 may include a far-end signal receiver 110, a near-end signal receiver 120, one or more Short-time Fourier transform (STFT) component 130, and a processing block 140. It is to be understood that although two signal receivers are shown in FIG. 1, any number of signal receivers may be included in the system 100. The system 100 may be implemented in one or more networks (e.g., enterprise network), one or more endpoints, one or more servers, or one or more clouds. A server may include hardware or software which manages access to a centralized resource or service in a network. A cloud may include a cluster of servers and other devices that are distributed across a network.

The system 100 may be implemented on or as various devices such as landline phone, mobile phone, tablet, server, desktop computer, laptop computer, vehicle (e.g., car, truck, boat, train, autonomous vehicle, electric scooter, electric bike), etc. The processing block 140 may communicate with the signal receivers 110 and 120, and other computing devices or components. The far-end signal receiver 110 and the near-end signal receiver 120 may be co-located or otherwise in close proximity of each other. For example, the far-end signal receiver 110 may refer to a speaker (e.g., a sound generating apparatus that converts electrical impulses to sounds) of a mobile phone, or a speaker (e.g., a sound generating apparatus inside a vehicle), and the near-end signal receiver 120 may refer to a voice input device (e.g., a microphone) of the mobile phone, a voice input device inside the vehicle, or another type of sound signal receiving apparatus. In some embodiments, the “far-end” signal may refer to an acoustic signal from a remote microphone picking up a remote talker’s voice; and the “near-end” signal may refer to the acoustic signal picked up by a local microphone, which may include a local talker’s voice and an echo generated based on the “far-end” signal. For example, assuming person A and person B are communicating through their respective mobile phones, person A's voice input to the microphone of person A's phone may be referred to as a “far-end” signal from person B's perspective. When person A's voice input is output from the speaker of person B's phone (e.g., a “far-end” signal receiver 110), an echo of person A's voice input (through propagation) may be picked up by the microphone of person B's microphone (e.g., the “near-end” signal receiver 120). The echo of person A's voice may be mixed with person B's voice when person B is talking to the microphone, which may be collectively referred to the “near-end” signal. In some embodiments, the far-end signal is not only received by the far-end signal receiver 110, but also sent to the processing block 140 directly through various communication channels. Exemplary communication channels may include Internet, a local network (e.g., LAN) or through direct communication (e.g., BLUETOOTH™, radio frequency, infrared).

In some embodiments, the near-end signal receiver 120 may receive a far-end acoustic signal and a corrupted near-end acoustic signal, wherein the corrupted near-end acoustic signal is generated based on (1) a corrupted signal generated from the far-end acoustic signal and (2) a near-end acoustic signal. The “corrupted signal generated from the far-end acoustic signal” may refer to an echo of the far-end acoustic signal. With the denotations in FIG. 1, x(t) may refer to a far-end signal (also called a reference signal) that is received by the far-end signal receiver 110 (e.g., speaker), propagated from the receiver 110 and through various reflection paths h(t), and then mixed with the near-end signal s(t) at the near-end signal receiver 120 (e.g., microphone). The near-end signal receiver 120 may yield a signal d(t) comprising an echo. The echo may also be called as a modified/corrupted version of the far-end signal x(t), which may include speaker distortion and other types of signal corruption caused when the far-end signal x(t) is propagated through an echo path h(t) . In some embodiments, the audio signals such as x(t) and d(t) may need to be transformed to log magnitude spectra in order to be processed by the processing block 140, and the output log magnitude spectra from the processing block 140 may similarly be transformed by one of the STFT components 130 to an audio signal e(t) as an output. Such transformations between audio signals and log magnitude spectra may be implemented by the one or more STFT components 130 in FIG. 1. An STFT component 130 may refer to a powerful general-purpose tool for audio signal processing. For example, one of the STFT components 130 may transform the far-end signal x(t) into a log magnitude spectra X(n, k), where n may refer to the time dimension of the signal, and k may refer to the frequency dimension of the signal.

In some embodiments, the processing block 140 of the system 100 may be configured to suppress or cancel the acoustic echoes in the input from the near-end signal receiver 120 by feeding the far-end acoustic signal and the corrupted near-end acoustic signal into a neural network as an input to output a time-frequency (TF) mask that suppresses the corrupted signal and retains the near-end acoustic signal, wherein: the neural network comprises an encoder and a decoder coupled to each other, the encoder comprises one or more convolutional layers, and the decoder comprises one or more deconvolutional layers that are respectively mapped to the one or more convolutional layers, wherein the input of the neural network passes through the convolutional layers and the deconvolutional layers. In some embodiments, the TF mask output from the neural network may be applied to the input echo-corrupted signal received by the near-end signal receiver 120 to generate an enhanced signal.

As shown in FIG. 1, the input from the near-end signal receiver 120 may refer to the input echo-corrupted signal d(t), and the output of the system 100 may refer to an enhanced signal e(t) by cleaning (suppressing or canceling) the acoustic echo from the d(t). As described in the Background section, conventional AEC solutions may implement an adaptive filter (may also be called a linear echo canceller) in the processing block 140 to estimate the echo paths h(t) (denoted as ĥ(t)), and subtract the estimated echo y(t) = ĥ(t) _{*} x(t). However, the linear echo canceller is under the assumption of a linear relationship between the far-end signal (reference signal) and the acoustic echo, which is often inaccurate or incorrect because of the nonlinearity introduced due to hardware limitations, like the speaker saturation.

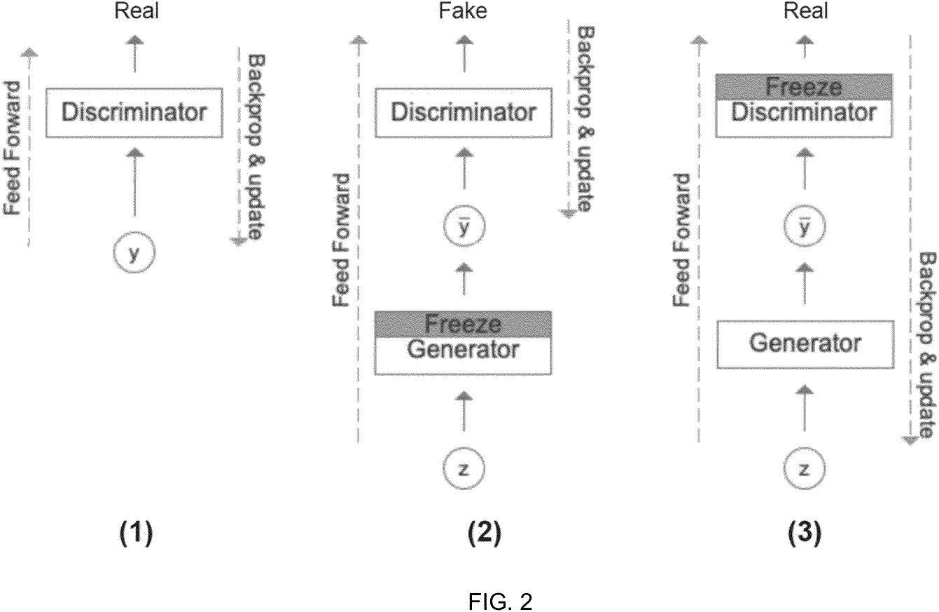

In order to handle both linear and nonlinear acoustic echo cancellation properly, the methods and systems described in this disclosure may train the processing block 140 with Generative Adversarial Network (GAN) model. Under the GAN model, a generator neural network G and a discriminator neural network D may be jointly trained in an adversarial manner. The trained G network may be deployed in the processing block 140 to perform the signal enhancement. The inputs to the trained G network may include the log magnitude spectra of the near-end corrupted signal (e.g., D(n, k) in FIG. 1) and the reference signal (e.g., X(n, k) in FIG. 1), and the output of the G network may include a Time-Frequency (TF) mask, denoted as Mask(n, k) = G{D(n, k),X(n, k)}. The TF mask generated by the G network may be applied to the log magnitude spectra of the near-end corrupted signal to resynthesize the enhanced version. For example, the mask Mask(n, k) maybe applied to D(n, k) to generate E(n, k) = Mask(n, k) _{*} D(n, k), which may then be transformed to the enhanced signal e(t) through an STFT component 130. An exemplary training process of the generator G and the corresponding discriminator D is illustrated in FIG. 2.

FIG. 2 illustrates an exemplary training process for GAN-based AEC, in accordance with various embodiments. Under a GAN framework, two competing networks may be jointly trained in an adversarial manner. The “networks” here may refer to neural networks. In some embodiments, the two competing networks may include a generator network G and a discriminator network D, which form a min-max game scenario. For example, the generator network G may try to generate fake data to fool the discriminator D, and D may learn to discriminate between real and fake data. In some embodiments, G does not memorize input-output pairs, instead, it may learn to map the data distribution characteristics to the manifold defined in prior (denoted as Z); D may be implemented as a binary classifier, and its input is either real samples from the dataset that G is imitating, or fake samples made up by G.

In the context of AEC, the generator G and the discriminator D may be trained with the training process illustrated in FIG. 2. FIG. 2 section (1) shows that the discriminator may be trained based on real samples with ground truth labels, so that it classifies the real samples as real. During the feed-forward phase for training the discriminator, real samples may be fed into the discriminator hoping the resulting classification is “real.” The resulting classification may then be backpropagated to update the parameters of the discriminator. For example, if the resulting classification is “real,” the parameters of the discriminator may be reinforced to increase the likelihood of the correct classification; if the resulting classification is “fake” (a wrong classification), the parameters of the discriminator may be adjusted to lower the likelihood of the incorrect classification.

FIG. 2 section (2) illustrates an interaction between the generator and the discriminator during the training process. During the feed-forward phase of the training process, the input “z” to the generator may refer to the corrupted signal (e.g., the log magnitude spectra of the near-end corrupted signal D(n, k) in FIG. 1). The generator may process the corrupted signal and try to generate an enhanced signal, denoted as y̅, to approximate the real sample y and fool the discriminator. The enhanced signal y̅ may be fed into the discriminator for a classification. The resulting classification of the discriminator may be backpropagated to update the parameters of the discriminator. For example, when the discriminator correctly classifies the enhanced signal y̅ generated from the generator as “fake,” the parameters of the discriminator may be reinforced to increase the likelihood of the correct classification. In some embodiments, the discriminator may be trained based on both fake samples and real samples with ground truth labels, as shown in FIG. 2 section (1) and section (2).

FIG. 2 section (3) illustrates another interaction between the generator and the discriminator during the training process. During the feed-forward phase of the training process, the input “z” to the generator may refer to the corrupted signal. Similar to FIG. 2 section (2), the generator may process the corrupted signal and generate an enhanced signal y̅ to approximate the real sample y. The enhanced signal y̅ may be fed into the discriminator for a classification. The resulting classification may then be backpropagated to update the parameters of the generator. For example, if the discriminator classifies the enhanced signal y̅ as “real,” the parameters of the generator may be turned to further improve the likelihood to fool the discriminator.

In some embodiments, the generator network and the discriminator network may be trained alternatively. For example, at any given point time in the training process, one of the generator network and the discriminator network may be frozen so that the parameters of the other network may be updated. As shown in FIG. 2 section (2), the generator is frozen so that the discriminator may be updated; and in FIG. 2 section (3), the discriminator is frozen so that the generator may be updated.

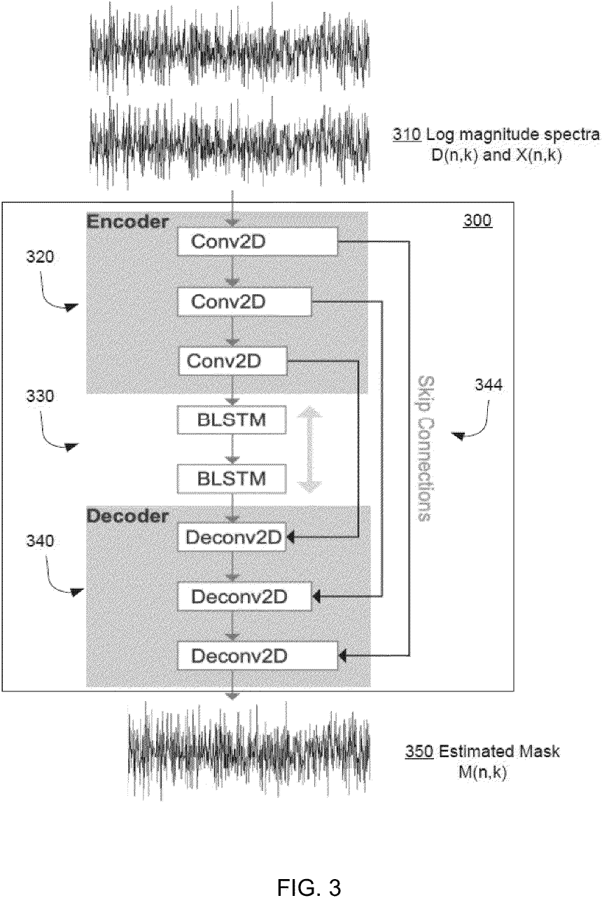

FIG. 3 illustrates an exemplary architecture of a generator 300 for GAN-based AEC, in accordance with various embodiments. The generator 300 in FIG. 3 is for illustrative purposes. Depending on the implementation, the generator 300 may include more, fewer, or alternative components or layers as shown in FIG. 3. The formats of the input 310 and output 350 of the generator 300 in FIG. 3 may vary according to specific application requirements. The generator 300 in FIG. 3 may be trained by the training process described in FIG. 2.

In some embodiments, the generator 300 may include an encoder 320 and a decoder 340. The encoder 320 may include one or more 2-D convolutional layers. In some embodiments, the one or more 2-D convolutional layers may be followed by a reshape layer (not shown in FIG. 3). The reshape layer may refer to an assistant tool to connect various layers in the encoder. These convolutional layers may enforce the generator 300 to focus on temporally-close correlations in the input signal. In some embodiments, the decoder 340 may be a reversed version of the encoder 320 that includes one or more 2-D convolutional layers that are reversely corresponding to the 2-D convolution layers in the encoder 320. In some embodiments, one or more bidirectional Long Short-term Memory (BLSTM) layers 330 may be deployed to capture other temporal information from the input signal. In some embodiments, batch normalization (BN) is applied after each convolution layer in the encoder 320 and decoder 340 except for the output layer (e.g., the last convolution layer in the decoder 340). In some embodiments, exponential linear units (ELU) may be used as activation functions for each layer except for the output layer, which may use a sigmoid activation function. In FIG. 3, the encoder 320 of the exemplary generator 300 includes three 2-D convolution layers, and the decoder 340 of the exemplary generator 300 may include three 2-D (de)convolution layers that are reversely corresponding to the three 2-D convolution layers in the encoder 320.

In some embodiments, each 2-D convolution layer in the encoder 320 may have a skip connection (SC) 344 connected to the corresponding 2-D convolution layer in the decoder 340. As shown in FIG. 3, the first 2-D convolution layer of the encoder 320 may have an SC 344 connected to the third 2-D convolution layer of the decoder 340. The SC 344 may be configured to pass fine-grained information of the input spectra from the encoder 320 to the decoder 340. The fine-grained information may be complimentary with the information flowed through and captured by the 2-D convolution layers in the encoder 320, and allow the gradients to flow deeper through the generator 300 network to achieve a better training behavior.

In some embodiments, the inputs 310 of the generator 300 may comprise log magnitude spectra of the near-end corrupted signal (e.g., D(n, k) in FIG. 1 from a microphone) and the reference signal (e.g., X(n, k) in FIG. 1). For example, the D(n, k) and X(n, k) may be assembled as one single input tensor for the generator 300, or may be fed into the generator 300 as two separate input tensors.

In some embodiments, the output 350 of the generator 300 may comprise an estimated time-frequency mask for resynthesizing an enhanced version of the near-end corrupted signal. For example, denoting the mask as Mask(n, k) = G{D(n, k),X(n, k)}, applying the mask to the log magnitude spectra of the near-end corrupted signal D(n, k) will generate an enhanced version E(n, k) = Mask(n, k) _{*} D(n, k). The expectation is that the enhanced version E(n, k) approximates the log magnitude spectra of the reference signal X(n, k).

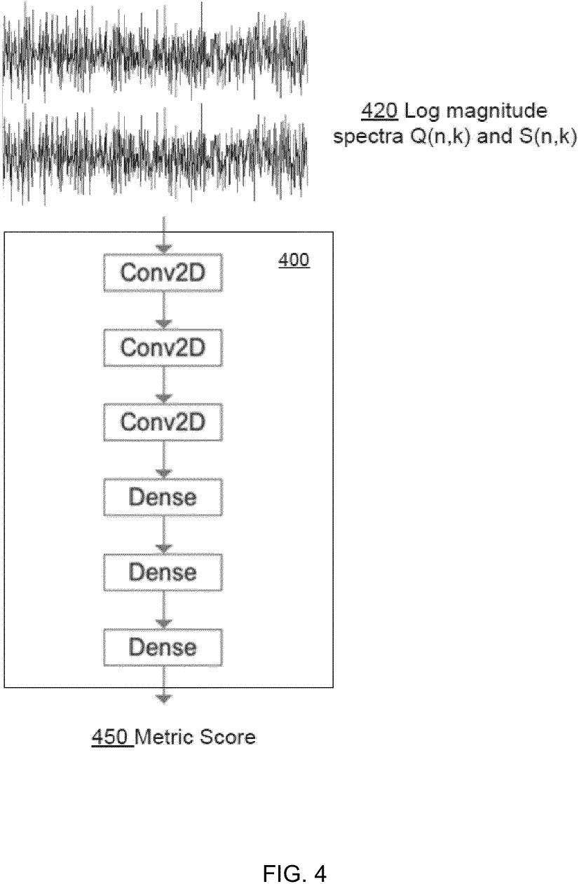

FIG. 4 illustrates an exemplary architecture of a discriminator 400 for GAN-based AEC, in accordance with various embodiments. The discriminator 400 in FIG. 4 is for illustrative purposes. Depending on the implementation, the discriminator 400 may include more, fewer, or alternative components or layers as shown in FIG. 4. The formats of the input 420 and output 450 of the discriminator 400 in FIG. 4 may vary according to specific application requirements. The discriminator 400 in FIG. 4 may be trained by the training process described in FIG. 2.

As described above, the discriminator 400 may be configured to evaluate the output of the generator network (e.g., 300 in FIG. 3). In some embodiments, the evaluation may include classifying an input (e.g., generated based on the output of the generator network) as real or fake, such as the generator network can slightly adjust its parameters to get rid of the echo components classified as fake and move the output towards the realistic signal distribution.

In some embodiments, the discriminator 400 may include one or more 2-D convolutional layers, a fatten layer, and one or more fully connected layers. The number of 2-D convolution layers in the discriminator 400 may be the same as the number in the generator network (e.g., 300 in FIG. 3).

In some embodiments, the input 420 of the discriminator 400 may include log magnitude spectra of the enhanced version of the near-end corrupted signal and a ground-truth signal. The ground-truth signal is known and part of the training data. For example, the log magnitude spectra of the enhanced version of the near-end corrupted signal may refer to E(n, k) = Mask(n, k) _{*} D(n, k), where Mask(n, k) refers to the output of the generator network; and the ground-truth signal S(n, k) may refer to a clean near-end signal (e.g., a speech received by the microphone) or a noisy near-end signal (e.g., the microphone signal including the received speech and other noises). The discriminator may determine whether the input E(n, k) should be classified as real or fake based on the S(n, k). In some embodiments, the classification result may be the output 450 of the discriminator 400.

In some embodiments, besides classifying the enhanced version of the near-end corrupted signal E(n, k) based on the ground-truth signal S(n, k), the discriminator may also evaluate the output of the generator, e.g., the T-F mask, directly against a ground-truth mask. For example, the input 420 of the discriminator 400 may include a ground-truth mask determined based on the near-end corrupted signal and the ground-truth signal, and the output 450 of the discriminator 400 may include a metric score quantifying the similarity between the ground-truth mask and the mask generated by the generator network.

In some embodiments, the loss functions of the generator network 300 in FIG. 3 and the discriminator network 400 in FIG. 4 may be formulated as follow:

$$\begin{matrix}{min}_{D} V \left(D\right) = {E}_{\left(z , y\right) ∼ \left(Z , Y\right)} \left[{\left(D \left(y , y\right) - Q \left(y , y\right)\right)}^{2}\right] \\ + {E}_{\left(z , y\right) ∼ \left(Z , Y\right)} \left[\left(D \left(G \left(z\right) , y\right)\right) - Q {\left(G \left(z\right) , \left(y\right)\right)}^{2}\right]\end{matrix}$$

$${min}_{G} V \left(G\right) = {E}_{z , y ∼ \left(Z , Y\right)} \left[{\left(D \left(G \left(z\right) , y\right) - 1\right)}^{2}\right]$$

where Q refers to a normalized evaluation metric with output in a range of [0, 1 ] (1 means the best, thus Q(y,y)=1), D refers to the discriminator network 400 in FIG. 4, G refers to the generator network 300 in FIG. 3, z refers to the near-end corrupted signal, Z refers to the distribution of z, y refers to the reference signal, and Y refers to the distribution of y, and E refers to the expectation of a formula by using a variable selected from a distribution. In some embodiments, Q may be implemented as a perceptual evaluation of speech quality (PESO) metric, an echo return loss enhancement (ERLE) metric, or a combination (weighted sum) of these two metrics. The PESO metric may evaluate the perceptual quality of the enhanced near-end speech during a double talk period (e.g., both the near-end talker and the far-end talker are active), and a PESO score may be calculated by comparing the enhanced signal to the ground-truth signal. An ERLE score may measure the echo reduction achieved by applying the mask generated by the generator network during single-talk situations where the near-end talker is inactive. In some embodiments, the discriminator network D may generate the metric score 450 as a PESO score, an ERLE score, or a hybrid score that is a weighted sum of a PESO score and an ERLE score.

For example, E(_{z,y})∼(_{Z,Y}) [(D(G(z), y) - 1)²] refers to the expectation of (D(G(z), y) - 1)² based on the pairs (z, y) selected from the distribution (Z, Y), where G(z) refers to the generator network with input z (e.g., the reference signal y may be implied as another input to the generator G), D(G(z),y) refers to the discriminator network with input G(z) (e.g., the output of the generator may be included as an input to the discriminator) and y. The above formula (1) may aim to train the discriminator to classify “real” signals as “real” (corresponding to the first half of (1)), and classify “fake” signals as “fake” (corresponding to the second half of (1)). The above formula (2) may aim to train the generator G so that the trained G can generate fake signals that the D may classify as “real.”

In some embodiments, the above formula (2) may be further expanded by adding an L2 norm (a standard method to compute the length of a vector in Euclidean space), denoted as:

$$\begin{matrix}{min}_{G} V \left(G\right) = {E}_{z , y ∼ \left(Z , Y\right)} \left[{\left(D \left(G \left(z\right) , y\right) - 1\right)}^{2}\right] \\ + λ {\left‖G \left(z\right) - Y\right‖}^{2}\end{matrix}$$

where λ||G(z) - Y||² refers to the Euclidean distance between the TF mask output by the generator G and the group truth TF mask generated based on the ground truth signal.

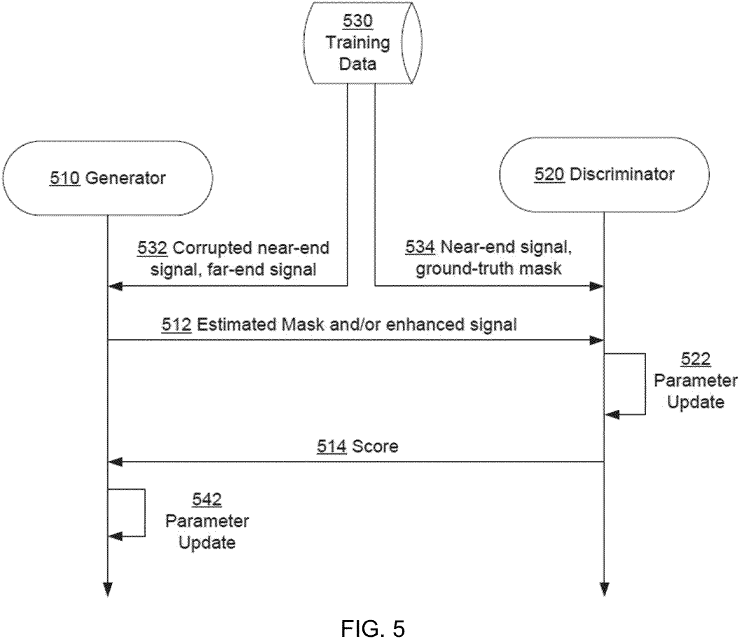

FIG. 5 illustrates another exemplary training process of a generator and a discriminator for GAN-based AEC, in accordance with various embodiments. As shown, the training process requires a set of training data 530, which may include a plurality of training far-end acoustic signals, training near-end acoustic signals, and corrupted versions of the training near-end acoustic signals. In some embodiments, the training data 530 may also include ground-truth masks that, when applied to the corrupted versions of the training near-end acoustic signals, reveal the training near-end acoustic signals.

An exemplary training step may start with obtaining training data comprising a training far-end acoustic signal, a training near-end acoustic signal, and a corrupted version of the training near-end acoustic signal, generating an estimated TF mask by the generator neural network based on the training far-end acoustic signal and the corrupted version of the training near-end acoustic signal, and obtaining an enhanced version of the training near-end acoustic signal by applying the estimated TF mask to the corrupted version of the training near-end acoustic signal.

For example, a corrupted near-end signal and a far-end signal 532 may be fed into the generator network 510 to generate an estimated mask, which may be applied to the corrupted near-end signal to cancel or suppress the acoustic echo in the corrupted near-end signal in order to generate an enhanced signal. The estimated mask and/or the enhanced signal may be sent to the discriminator 520 for evaluation at step 512.

The training step may then continue to generate, by the discriminator neural network, a score quantifying a resemblance between the enhanced version of the training near-end acoustic signal and the training near-end acoustic signal. For example, the discriminator 520 may generate a score based on (1) the estimated mask and/or the enhanced signal received from the generator 510 and (2) the near-end signal and/or the ground-truth mask 534 corresponding to the corrupted near-end signal and the far-end signal 532. The near-end signal and/or the ground-truth mask 534 may be obtained from the training data 530. For example, the discriminator 520 may generate a first score quantifying the resemblance between the estimated mask and the ground-truth mask, or a second score evaluating the quality of acoustic echo cancellation/suppression based on the enhanced signal and the near-end signal. As another example, the score generated by the discriminator may be a weighted sum of the first and second scores. During this process, the discriminator 520 may update its parameters so that it has a higher probability to generate a higher score when the data received at step 512 are closer to the near-end signal and/or the ground-truth mask 534, and a lower score otherwise.

Subsequently, the generated score may be sent back to the generator 510 at step 514 for the generator 510 to update its parameters at step 542. For example, a low score means the mask generated by the generator 510 was not “realistic” enough to “fool” the discriminator 520. Accordingly, the generator 510 may adjust its parameters accordingly to lower the probability of generating such mask for such input (e.g., the corrupted near-end signal and the far-end signal 532).

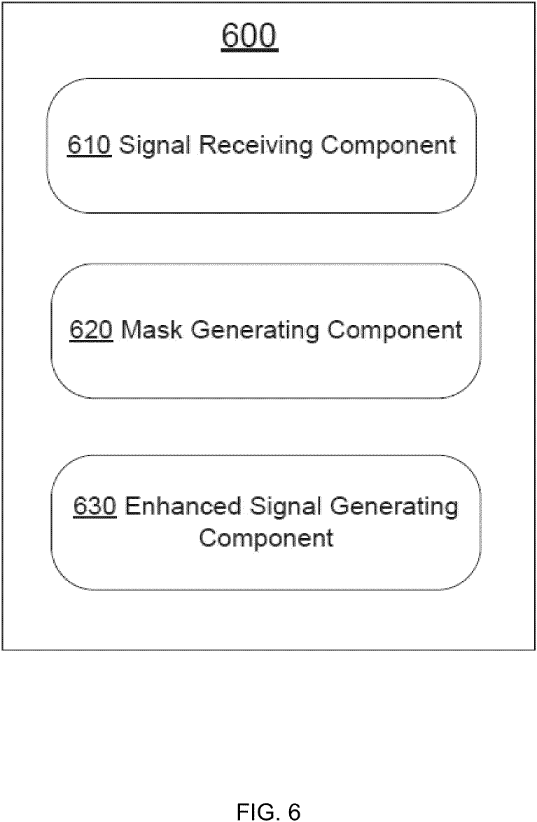

FIG. 6 illustrates a block diagram of a computer system apparatus 600 for GAN-based AEC in accordance with various embodiments. The components of the computer system 600 presented below are intended to be illustrative. Depending on the implementation, the computer system 600 may include additional, fewer, or alternative components.

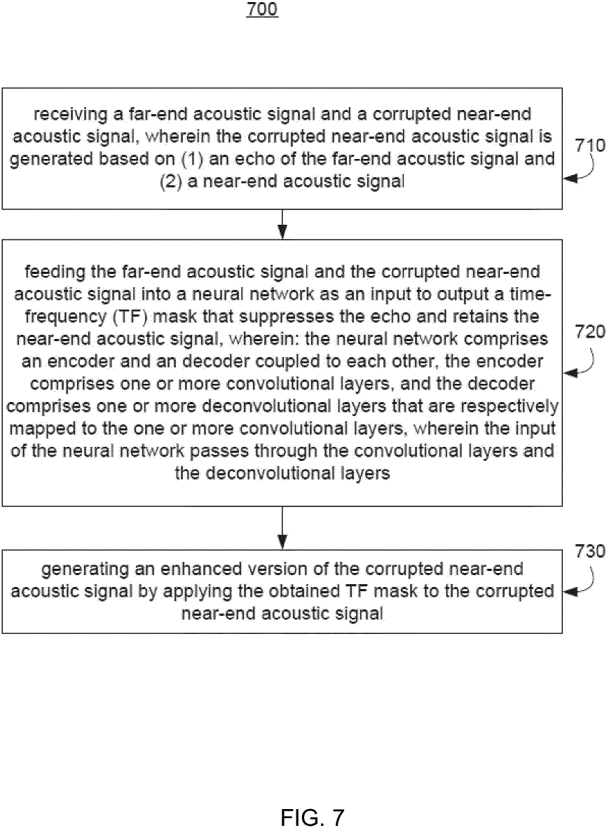

The computer system 600 may be an example of an implementation of the processing block of FIG. 1. The example training process illustrated in FIG. 5 may be implemented by the computer system 600. The computer system 600 may comprise one or more processors and one or more non-transitory computer-readable storage media (e.g., one or more memories) coupled to the one or more processors and configured with instructions executable by the one or more processors to cause the system or device (e.g., the processor) to perform the above-described method, e.g., the method 700 in FIG. 7. The computer system 600 may comprise various units/modules corresponding to the instructions (e.g., software instructions).

In some embodiments, the computer system 600 may be referred to as an apparatus for GAN-based AEC. The apparatus may comprise a signal receiving component 610, a mask generating component 620, and an enhanced signal generating component 630. In some embodiments, the signal receiving component 610 may be configured to receive a far-end acoustic signal and a corrupted near-end acoustic signal, wherein the corrupted near-end acoustic signal is generated based on (1) an echo of the far-end acoustic signal and (2) a near-end acoustic signal. In some embodiments, the mask generating component 620 may be configured to feed the far-end acoustic signal and the corrupted near-end acoustic signal into a neural network as an input to output a time-frequency (TF) mask that suppresses the echo and retains the near-end acoustic signal, wherein: the neural network comprises an encoder and a decoder coupled to each other, the encoder comprises one or more convolutional layers, and the decoder comprises one or more deconvolutional layers that are respectively mapped to the one or more convolutional layers, wherein the input of the neural network passes through the convolutional layers and the deconvolutional layers. In some embodiments, the enhanced signal generating component 630 may be configured to generate an enhanced version of the corrupted near-end acoustic signal by applying the obtained TF mask to the corrupted near-end acoustic signal.

FIG. 7 illustrates an exemplary method 700 for GAN-based AEC in accordance with various embodiments. The method 700 may be implemented in an environment shown in FIG. 1. The method 700 may be performed by a device, apparatus, or system illustrated by FIGS. 1-6, such as system 102. Depending on the implementation, the method 700 may include additional, fewer, or alternative steps performed in various orders or parallel.

Block 710 includes receiving a far-end acoustic signal and a corrupted near-end acoustic signal, wherein the corrupted near-end acoustic signal is generated based on (1) a corrupted signal (e.g., an echo) generated from the far-end acoustic signal and (2) a near-end acoustic signal. In some embodiments, the corrupted signal generated from the far-end acoustic signal is obtained by a near-end device when the far-end acoustic signal is propagated from a far-end device to the near-end device.

Block 720 includes feeding the far-end acoustic signal and the corrupted near-end acoustic signal into a neural network as an input to output a time-frequency (TF) mask that suppresses the corrupted signal and retains the near-end acoustic signal, wherein: the neural network comprises an encoder and a decoder coupled to each other, the encoder comprises one or more convolutional layers, and the decoder comprises one or more deconvolutional layers that are respectively mapped to the one or more convolutional layers, wherein the input of the neural network passes through the convolutional layers and the deconvolutional layers. In some embodiments, the neural network further comprises one or more bidirectional Long-Short Term Memory (LSTM) layers between the encoder and the decoder. In some embodiments, each of the convolution layers has a direct channel to pass data directly to a corresponding deconvolution layer through a skip connection. In some embodiments, the far-end acoustic signal comprises a speaker signal, the near-end acoustic signal comprises a target microphone input signal to a microphone, the corrupted signal generated from the far-end acoustic signal comprises an echo of the speaker signal that is received by the microphone, and the corrupted near-end acoustic signal comprises the target microphone input signal and the echo.

In some embodiments, the neural network comprises a generator neural network jointly trained with a discriminator neural network by: obtaining training data comprising a training far-end acoustic signal, a training near-end acoustic signal, and a corrupted version of the training near-end acoustic signal; generating an estimated TF mask by the generator neural network based on the training far-end acoustic signal and the corrupted version of the training near-end acoustic signal; obtaining an enhanced version of the training near-end acoustic signal by applying the estimated TF mask to the corrupted version of the training near-end acoustic signal; generating, by the discriminator neural network, a score quantifying a resemblance between the enhanced version of the training near-end acoustic signal and the training near-end acoustic signal; and training the generator neural network based on the generated score.

In some embodiments, a loss function for training the discriminator neural network comprises a normalized evaluation metric that is determined based on: a perceptual evaluation of speech quality (PESO) metric of the enhanced version of the training near-end acoustic signal; an echo return loss enhancement (ERLE) metric of the enhanced version of the training near-end acoustic signal; or a weighted sum of the PESO metric and the ERLE metric of the enhanced version of the training near-end acoustic signal. In some embodiments, the discriminator neural network comprises one or more convolutional layers and one or more fully connected layers. In some embodiments, the generator neural network and the discriminator neural network are jointly trained as a Generative Adversarial Network (GAN). In some embodiments, training the generator neural network and the discriminator neural network alternatively.

In some embodiments, the score comprises: a perceptual evaluation of speech quality (PESO) score of the enhanced version of the training near-end acoustic signal; an echo return loss enhancement (ERLE) score of the enhanced version of the training near-end acoustic signal; or a weighted sum of the PESQ score and the ERLE score.

In some embodiments, the training data further comprises a ground-truth mask based on the training far-end acoustic signal, the training near-end acoustic signal, and the corrupted version of the training near-end acoustic signal, and the score further comprises a normalized distance between the ground-truth mask and the estimated TF mask.

Block 730 includes generating an enhanced version of the corrupted near-end acoustic signal by applying the obtained TF mask to the corrupted near-end acoustic signal.

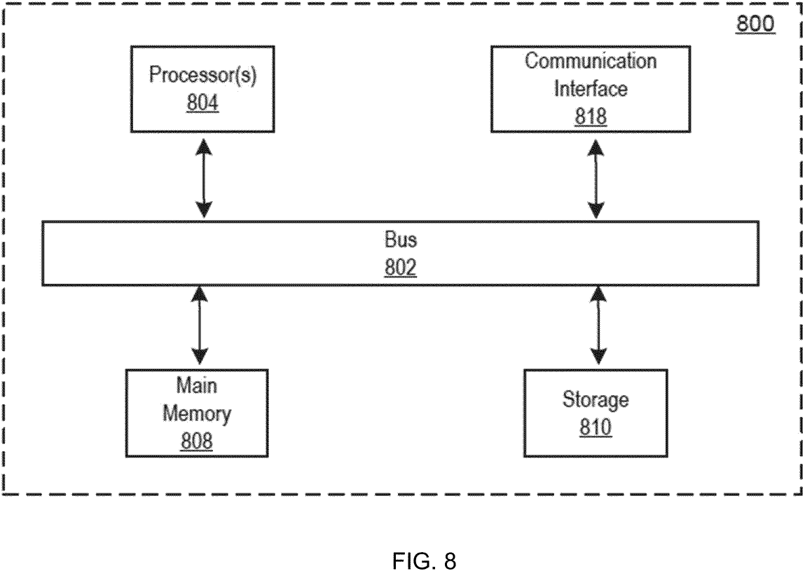

FIG. 8 illustrates an example computing device in which any of the embodiments described herein may be implemented. The computing device may be used to implement one or more components of the systems and the methods shown in FIGS. 1-7. The computing device 800 may comprise a bus 802 or other communication mechanism for communicating information and one or more hardware processors 804 coupled with bus 802 for processing information. Hardware processor(s) 804 may be, for example, one or more general-purpose microprocessors.

The computing device 800 may also include a main memory 808, such as a random-access memory (RAM), cache and/or other dynamic storage devices 810, coupled to bus 802 for storing information and instructions to be executed by processor(s) 804. Main memory 808 also may be used for storing temporary variables or other intermediate information during execution of instructions to be executed by processor(s) 804. Such instructions, when stored in storage media accessible to processor(s) 804, may render computing device 800 into a special-purpose machine that is customized to perform the operations specified in the instructions. Main memory 808 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, or networked versions of the same.

The computing device 800 may implement the techniques described herein using customized hard-wired logic, one or more ASICs or FPGAs, firmware and/or program logic which in combination with the computing device may cause or program computing device 800 to be a special-purpose machine. According to one embodiment, the techniques herein are performed by computing device 800 in response to processor(s) 804 executing one or more sequences of one or more instructions contained in main memory 808. Such instructions may be read into main memory 808 from another storage medium, such as storage device 810. Execution of the sequences of instructions contained in main memory 808 may cause processor(s) 804 to perform the process steps described herein. For example, the processes/methods disclosed herein may be implemented by computer program instructions stored in main memory 808. When these instructions are executed by processor(s) 804, they may perform the steps as shown in corresponding figures and described above. In alternative embodiments, hard-wired circuitry may be used in place of or in combination with software instructions.

The computing device 800 also includes a communication interface 818 coupled to bus 802. Communication interface 818 may provide a two-way data communication coupling to one or more network links that are connected to one or more networks. As another example, communication interface 818 may be a local area network (LAN) card to provide a data communication connection to a compatible LAN (or WAN component to communicate with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

1. A computer-implemented method, the method comprising:
receiving a far-end acoustic signal and a corrupted near-end acoustic signal, wherein the corrupted near-end acoustic signal is generated based on an echo of the far-end acoustic signal and a near-end acoustic signal;
feeding the far-end acoustic signal and the corrupted near-end acoustic signal into a neural network as an input to output a time-frequency (TF) mask that suppresses the echo and retains the near-end acoustic signal, wherein:
the neural network includes an encoder and a decoder coupled to each other,
the encoder includes one or more convolutional layers, and
the decoder includes one or more deconvolutional layers that are respectively mapped to the one or more convolutional layers, wherein an input of the neural network passes through the convolutional layers and the deconvolutional layers; and
generating an enhanced version of the corrupted near-end acoustic signal by applying the obtained TF mask to the corrupted near-end acoustic signal.

2. The method of claim 1, wherein the echo of the far-end acoustic signal is received by a near-end device when the far-end acoustic signal is propagated from a far-end device to the near-end device.

3. The method of claim 1, wherein the neural network includes a generator neural network jointly trained with a discriminator neural network by:
obtaining training data including a training far-end acoustic signal, a training near-end acoustic signal, and a corrupted version of the training near-end acoustic signal;
generating an estimated TF mask by the generator neural network based on the training far-end acoustic signal and the corrupted version of the training near-end acoustic signal;
obtaining an enhanced version of the training near-end acoustic signal by applying the estimated TF mask to the corrupted version of the training near-end acoustic signal;
generating, by the discriminator neural network, a score quantifying a resemblance between the enhanced version of the training near-end acoustic signal and the training near-end acoustic signal; and
training the generator neural network based on the generated score.

4. The method of claim 3, wherein a loss function for training the discriminator neural network includes a normalized evaluation metric that is determined based on:
a perceptual evaluation of speech quality (PESQ) metric of the enhanced version of the training near-end acoustic signal;
an echo return loss enhancement (ERLE) metric of the enhanced version of the training near-end acoustic signal; or
a weighted sum of the PESQ metric and the ERLE metric of the enhanced version of the training near-end acoustic signal.

5. The method of claim 3, wherein the discriminator neural network includes one or more convolutional layers and one or more fully connected layers.

6. The method of claim 3, wherein the generator neural network and the discriminator neural network are jointly trained as a Generative Adversarial Network (GAN).

7. The method of claim 3, further comprising:
training the generator neural network and the discriminator neural network alternatively.

8. The method of claim 3, wherein the score comprises:
a perceptual evaluation of speech quality (PESQ) score of the enhanced version of the training near-end acoustic signal;
an echo return loss enhancement (ERLE) score of the enhanced version of the training near-end acoustic signal; or
a weighted sum of the PESQ score and the ERLE score.

9. The method of claim 3, wherein the training data further-includes a ground-truth mask based on the training far-end acoustic signal, the training near-end acoustic signal, and the corrupted version of the training near-end acoustic signal, and
the score further includes a normalized distance between the ground-truth mask and the estimated TF mask.

10. The method of claim 1, wherein the neural network further-includes one or more bidirectional Long-Short Term Memory (LSTM) layers between the encoder and the decoder.

11. The method of claim 1, wherein each of the convolution layers has a direct channel to pass data directly to a corresponding deconvolution layer through a skip connection.

12. A system comprising one or more processors and one or more non-transitory computer-readable memories coupled to the one or more processors, the one or more non-transitory computer-readable memories storing instructions that, when executed by the one or more processors, cause the system to perform operations comprising:
receiving a far-end acoustic signal and a corrupted near-end acoustic signal, wherein the corrupted near-end acoustic signal is generated based on an echo of the far-end acoustic signal and a near-end acoustic signal;
feeding the far-end acoustic signal and the corrupted near-end acoustic signal into a neural network as an input to output a time-frequency (TF) mask that suppresses the echo and retains the near-end acoustic signal, wherein:
the neural network includes an encoder and a decoder coupled to each other,
the encoder includes one or more convolutional layers, and
the decoder includes one or more deconvolutional layers that are respectively mapped to the one or more convolutional layers, wherein an input of the neural network passes through the convolutional layers and the deconvolutional layers; and
generating an enhanced version of the corrupted near-end acoustic signal by applying the obtained TF mask to the corrupted near-end acoustic signal.

13. The system of claim 12, wherein the neural network includes a generator neural network jointly trained with a discriminator neural network by:
obtaining training data including a training far-end acoustic signal, a training near-end acoustic signal, and a corrupted version of the training near-end acoustic signal;
generating an estimated TF mask by the generator neural network based on the training far-end acoustic signal and the corrupted version of the training near-end acoustic signal;
obtaining an enhanced version of the training near-end acoustic signal by applying the estimated TF mask to the corrupted version of the training near-end acoustic signal;
generating, by the discriminator neural network, a score quantifying a resemblance between the enhanced version of the training near-end acoustic signal and the training near-end acoustic signal; and
training the generator neural network based on the generated score.

14. The system of claim 13, wherein a loss function for training the discriminator neural network includes a normalized evaluation metric that is determined based on:
a perceptual evaluation of speech quality (PESQ) metric of the enhanced version of the training near-end acoustic signal;
an echo return loss enhancement (ERLE) metric of the enhanced version of the training near-end acoustic signal; or
a weighted sum of the PESQ metric and the ERLE metric of the enhanced version of the training near-end acoustic signal.

15. The system of claim 12, wherein each of the convolution layers has a direct channel to pass data directly to a corresponding deconvolution layer through a skip connection.

16. A non-transitory computer-readable storage medium storing instructions that, when executed by one or more processors, cause the one or more processors to perform operations comprising:
receiving a far-end acoustic signal and a corrupted near-end acoustic signal, wherein the corrupted near-end acoustic signal is generated based on an echo of the far-end acoustic signal and a near-end acoustic signal;
feeding the far-end acoustic signal and the corrupted near-end acoustic signal into a neural network as an input to output a time-frequency (TF) mask that suppresses the echo and retains the near-end acoustic signal, wherein:
the neural network includes an encoder and a decoder coupled to each other,
the encoder includes one or more convolutional layers, and
the decoder includes one or more deconvolutional layers that are respectively mapped to the one or more convolutional layers, wherein an input of the neural network passes through the convolutional layers and the deconvolutional layers; and
generating an enhanced version of the corrupted near-end acoustic signal by applying the obtained TF mask to the corrupted near-end acoustic signal.

17. The storage medium of claim 16, wherein the neural network-includes a generator neural network jointly trained with a discriminator neural network by:
obtaining training data including a training far-end acoustic signal, a training near-end acoustic signal, and a corrupted version of the training near-end acoustic signal;
generating an estimated TF mask by the generator neural network based on the training far-end acoustic signal and the corrupted version of the training near-end acoustic signal;
obtaining an enhanced version of the training near-end acoustic signal by applying the estimated TF mask to the corrupted version of the training near-end acoustic signal;
generating, by the discriminator neural network, a score quantifying a resemblance between the enhanced version of the training near-end acoustic signal and the training near-end acoustic signal; and
training the generator neural network based on the generated score.

18. The storage medium of claim 16, wherein a loss function for training the discriminator neural network includes a normalized evaluation metric that is determined based on:
a perceptual evaluation of speech quality (PESQ) metric of the enhanced version of the training near-end acoustic signal;
an echo return loss enhancement (ERLE) metric of the enhanced version of the training near-end acoustic signal; or
a weighted sum of the PESQ score and the ERLE score.

19. The storage medium of claim 16, wherein each of the convolution layers has a direct channel to pass data directly to a corresponding deconvolution layer through a skip connection.

20. The storage medium of claim 16, the neural network further-includes one or more bidirectional Long-Short Term Memory (LSTM) layers between the encoder and the decoder.
